(19) United States
(12) Patent Application Publication
(10) Pub. No.: US 2006/0293783 A1
(43) Pub. Date: Dec. 28, 2006

(54) Intelligent cash control system

(76) Inventors: Peter Hand, Las Vegas, NV (US); Prashanth Kodela, Las Vegas, NV (US); Mark Hutchinson, Las Vegas, NV (US); Gwen D. Mathis, Las Vegas, NV (US)

Correspondence Address: JAMES D. ERICKSON;c/o JCM AMERICAN, 925 PILOT ROAD, LAS VEGAS, NV, 89119, US

(21) Appl. No.: 11/144,502

(22) Filed: Jun. 2, 2005

(51) Int. Cl. G06F 17/00

(52) U.S. Cl. 700/231; 235/381

(57) ABSTRACT

A lottery terminal or kiosk such as a video lottery terminal, a lottery ticket printing terminal and/or other remotely controlled retail or gaming kiosk, which allows for transactions of the type in which a user can deposit currency that is validated by a bill validator, and valid currency is stored in an intelligent cash box within the kiosk. The kiosk system then credits the user with credits equal to the amount received to allow the purchase of selected items such as lottery tickets. The system includes the components necessary to allow the selection and printing of lottery tickets, or other vended items, as appropriate. The system also includes the components necessary to allow independent monitoring of the intelligent cash box memory from a remote site. The memory of the intelligent cash box can be accessed and monitored through the bill validator by means of IrDA, RFID, or other wireless means.

### BACKGROUND OF THE INVENTION

This invention relates to the field of lottery terminals or kiosks and remotely controlled retail and/or gaming kiosks. More particularly, this invention relates to a cash management system and inventory control system for such devices and an intelligent cash control system to independently or redundantly monitor the handling of money within such systems.

There are presently over forty states which allow some type of lottery to be run by a state agency. Generally, state run lotteries have a numbers based lottery system with periodic random selections of three to six numbers from a set or field of numbers. Participants select their numbers and purchase tickets from authorized vendors, generally retail stores, prior to the selection date. Jackpots for these types of games are generally at least several million dollars and at times up to and exceeding one hundred million dollars. However, the lotteries also provide winning tickets and payouts for correct selection of less than all of the jackpot numbers. These tickets may be redeemed for cash values in the range of $1 to $100 dollars by the authorized vendors.

These types of interactive lottery games rely on systems to dispense purchased tickets and validate the winning tickets. The systems generally include a point of sale transaction terminal which allows the player to enter or select a set of numbers, pay for and receive a printed ticket. For example, in a Pick Five or Pick Six system, the player identifies the numbers selected on a card which is scanned in to produce a coded game or lottery ticket. The coded lottery ticket is provided by the cashier in exchange for a payment. Generally, the payments are deposited into the cashier station for the retail outlet mixed in with the receipts for all other sales, as opposed to being deposited into the terminal which prints the lottery ticket. The retail outlet must therefore account for the proceeds of the lottery ticket sales and provide payment to the state.

The terminals that print the game or lottery ticket, in addition to printing out the numbers selected by the player, generally also include some method of encoding information about the ticket or selected numbers. For example, the encoded information may be a bar code. The bar code can provide either an encoded version of the numbers selected or provide a serial number which represents the transaction for the set(s) of selected numbers. Generally, the ticket printing terminal communicates with a controlled host system which manages the state-wide lottery operation. The controlled host system records all tickets, including the number selections and encoded information about the ticket, generated by all of the ticket printing terminals. The amount of revenue that is received at each retail outlet for the sales of lottery tickets is also recorded and reported by the controlled host system. The controlled host system can generate a listing of all sales made at a terminal on a periodic basis so that the retail operator will know the amount to submit to the state.

However, due to the fact that the cashiers are handling the money and the retail outlets must provide to the state an accounting of the monies that they received, portions of which are retained for the store, there are inherent opportunities for store employees or third parties to interfere with the proper accounting transaction by which the State will receive its appropriate compensation for the sales of lottery tickets and by which the retailer will receive its compensation for its sales. Further, for many retail outlets, the holder of a game or lottery ticket must give the game or lottery ticket to the cashier to check for a winning ticket and there is the potential that a cashier could palm a winning ticket and provide a losing ticket to the player. Cashiers may also be responsible for paying out certain amounts on winning lottery tickets, for example up to $100, thereby introducing the potential for cashier errors in payouts.

Accordingly, it is contemplated that it would be beneficial to have an integrated terminal system whereby the payments for game or lottery tickets that are dispensed are received and stored within the ticket printing terminal in a secure cash box. Moreover, it would be beneficial to allow the cash box to have its own communication device so as to allow communication with the centralized host system both when the cash box is installed in the terminal system with the ticket printing system and when the cash box has been moved and is connected to a download terminal. It would also be beneficial to have such a terminal that could allow the automated purchase of game tickets and payouts of winning tickets.

### SUMMARY OF THE INVENTION

The present invention is directed to a lottery terminal or kiosk such as a video lottery terminal, a lottery ticket printing terminal and/or remotely controlled retail or gaming kiosk, which allows for transactions of the type in which a user can deposit currency that is validated by a bill validator, and valid currency is stored in a cash box within the kiosk. The kiosk system then credits the user with credits equal to the amount received to allow the purchase of selected items such as game or lottery tickets. The system includes the components necessary to allow the selection and printing of lottery tickets, or other vended items, as appropriate. The validator keeps track of all of the currency received as well as the value of the dispensed items such as the lottery tickets. In addition, the validator downloads to a memory device within an intelligent cash box (“ICB”) information concerning the value and denominations of all currency received and stored in the intelligent cash box (ICB) associated with the bill validator.

The intelligent cash box is capable of communicating both with the bill validator of the kiosk as well as communicating with the remote centralized host system capable of monitoring the position and status of the intelligent cash box (ICB). The communication to the bill validator can be provided, for example, by means of either an Infrared Data (“IrDA”) device or a Radio Frequency Identification (“RFID”) device incorporated into the intelligent cash box (ICB). In the case of a RFID device included in the ICB, the cash box memory for storing any relevant information can be included in the RFID device. The relevant information that could be retained in the ICB could be comprised of permanent and/or temporary rewritable identification numbers, transactions and/or event histories, content descriptions and totals, or any other type of information that could be deemed useful in tracking and/or monitoring proper collection, retention, and dispersion of notes by the ICB.

When the intelligent cash box is removed from the host kiosk, it provides a report to the host kiosk of its removal as well as its present status, for example, the total value and denominations of all notes that are stored in the intelligent cash box (ICB). The cash box memory of the intelligent cash box (ICB) is also preferably fixed or locked, so as to prevent re-writing but allow reporting once the intelligent cash box (ICB) is taken to a secured location for downloading of the information and removal of the retained currency. If required, certain segments of the information stored in the cash box memory could be protected by an encryption scheme such that only an authorized interface device or download terminal would be allowed to erase or alter the values stored therein.

Optionally, the intelligent cash box (ICB) can be provided with a remote location device such as a global positioning system (“GPS”) device or a Global System for Mobile Communications (“GSM”) device so as to allow tracking of the intelligent cash box (ICB) when it is removed from the host system. These and other aspects of the system will be described in more detail in connection with the attached drawings and the detailed description provided below.

### BRIEF DESCRIPTION OF THE DRAWINGS

FIG. 1 is a perspective view of an exemplary kiosk, such as a video lottery ticket kiosk.

FIG. 2 is a second perspective view of the video lottery ticket kiosk of FIG. 1 with a cover door opened.

FIG. 3 is a schematic representation of the electronic interface components of the kiosk of FIG. 1.

FIG. 4 is a schematic representation of a system incorporating the capability of communicating with distributed kiosks such as the kiosk of FIG. 1.

### DETAILED DESCRIPTION OF THE PREFERRED EMBODIMENTS

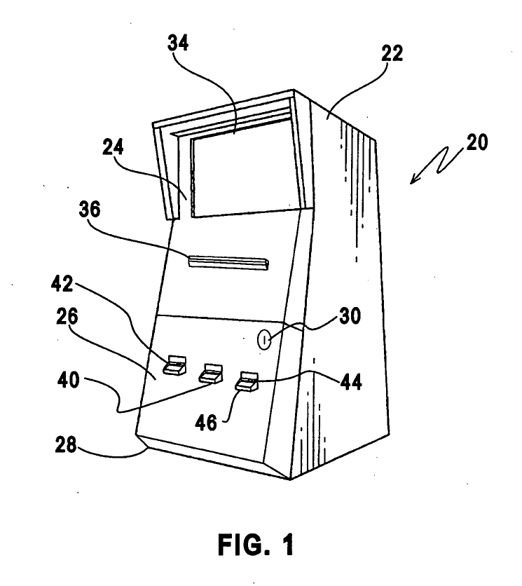

FIG. 1 depicts a perspective view of a video ticket (“VT”) kiosk 20. The VT kiosk 20 includes a housing 22 and a face plate 24 mounted to the housing 22. A portion of the face plate 24 is a door 26 attached to the housing 22 by a hinge 28. The door 26 is secured by a lock 30 to limit access to the interior of the VT kiosk 20. A kiosk controller/processor (not shown in FIG. 1) is mounted within the housing 22 to control the operation of the VT kiosk 20. The face plate 24 provides a mounting for a video screen 34, which may preferably be an interactive touch screen, and may also include a reader card slide 36 that may read magnetic data strips, bar codes and RFID devices from appropriate credit cards, cash cards and operator cards.

The door 26 includes a ticket dispense slot 40, a ticket receive slot 42 and a currency acceptor slot 44. The currency acceptor slot 44 is preferably positioned above a bezel 46 which provides a runway to assist proper placement of currency to be inserted into the currency acceptor slot 44 of the VT kiosk 20.

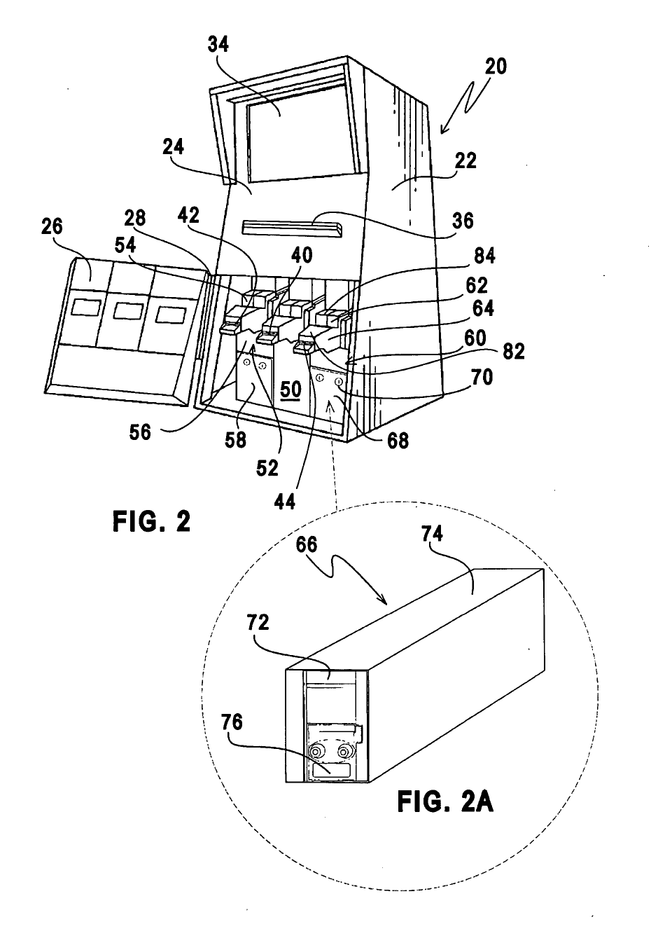

FIG. 2 depicts the VT kiosk 20 with the door 26 open to expose a ticket printer 50, a ticket acceptor 52 and a bill validator 60. The ticket printer 50 is configured to store a supply of printable tickets or a roll of paper and to include a printer element that can print required indicia onto a ticket and dispense the ticket, cutting off the ticket after it has been dispensed. Ticket printers of the type suitable for the application are common in use in lottery ticket terminals. The Ticket acceptor 52 has a validator 54, such as a bar code reader and optionally a stacker 56 secured behind a lockable door 58 that will stack the tickets which a player wants to cash out. Alternatively, the validator may simply read the tickets and provide an indication to the kiosk controller/processor to cause a display on the video screen 34 as to whether the ticket is a winning ticket and, if so, the amount of the pay out. Although illustrated separately, the bill validator 60 and the ticket acceptor 52 may be incorporated into one validator assembly, wherein the ticket receive slot 42 and the currency acceptor slot 44 could be one and the same. An example of such a bill validator, acceptor device is described in U.S. Pat. No. 6,742,644, issued Jun. 1, 2004 to Ray Heidel, the specification from which is herein incorporated by reference.

The VT kiosk 20 can be configured to allow the ticket acceptor 52 to receive the ticket and prompt the player via the video screen to determine if a pay out from the VT kiosk 20 is requested. If the player requests that the pay out be made, then a pay out from the bill validator 60 may be authorized by the kiosk controller/processor to dispense the appropriate amount of cash for the ticket and the ticket is canceled and stacked within the stacker 56. For this system, the bill validator 60 has the capability of receiving and storing notes and it may also be configured to pay out notes and/or to have a bill recycler so that currency that is received may be used to make corresponding pay outs on a winning ticket. A bill validator capable of accepting and dispensing multiple note denominations is described in U.S. Pat. No. 6,889,850, the detailed description of which is herein incorporated by reference.

The bill validator 60 preferably includes a validation assembly 62 and a transport assembly 64 mounted above a removable bill stacker cash box (ICB) 66. The validation assembly 62 can be comprised of a validator head 82 and a validator controller 84 having a cash box interface processor. Additionally an external communication link can be included in the validation assembly 62 for providing independent or redundant means for either wired or wireless communication to a monitoring or auditing system. Alternatively, the bill validator controller 84 could make external communications through the same communications link as used by the VT kiosk 20.

The bill validator's intelligent cash box (ICB) 66 is secured behind a door 68 that may include one or more locks 70 to secure the door 68 in a closed position. When the door 68 is opened, the intelligent cash box (ICB) 66 can be removed from the bill validator 60 for transport or for removal of currency stored therein. An exemplary intelligent cash box (ICB) 66 is depicted removed from the VT kiosk 20 in FIG. 2A. The intelligent cash box (ICB) 66 includes an access door 72 mounted to a box shaped housing 74. The intelligent cash box (ICB) 66 preferably includes an electronics assembly 76 having a cash box memory, and a cash box communications link as well as a GSM or GPS device, and battery power device, as necessary.

The cash box interface processor in the validator controller 84 of the validation assembly 62 provides the wireless coupling to the electronics assembly 76 within the intelligent cash box (ICB) 66. Since the intelligent cash box (ICB) 66 can be removed from the VT kiosk 20 housing to be replaced with a different cash box or emptied and subsequently returned, in order to avoid having repeated mechanical or electrical contacts being connected and disconnected, it is preferable to use a wireless data communication protocol between the cash box interface processor and the cash box electronics assembly 76. By this configuration, the bill acceptor may obtain data from, and write data to, the cash box memory of the electronics assembly 76.

For example, when an intelligent cash box (ICB) 66 which includes a note recycling system is inserted into the VT kiosk 20, it may include a stack of pre-selected bills. The information concerning the number and denomination of these bills may need to be downloaded from the memory of the electronics assembly 76 to the cash box interface processor of the validator controller 84 so that the validator controller 84 can track the amount of cash within the cash box 66. In addition, the cash box's memory, being in wireless communication with the validator controller 84, may log and record information regarding the accepted notes, coupons, and bill validation acceptor errors. In the instance where the memory of the electronics assembly 76 is part of an RFID tag device included in the electronics assembly 76, the RFID interface device for communicating with and downloading to the RFID tag device on the intelligent cash box (ICB) 66 is incorporated into the bill validator's cash box interface processor.

When the intelligent cash box (ICB) 66 is removed from the bill validator 60, the remote centralized host system preferably communicates with the RFID tag device in the intelligent cash box (ICB) by means of its own RFID interface device (not shown) to record the removal. If required, the RFID tag device can be programmed with an encryption scheme such that only authorized RFID interface devices can read and/or modify the data stored in the cash box's memory once the cash box is removed from the bill validator 60. Various schemes for encrypting such data contained in a RFID tag device are described in U.S. Pat. No. 6,130,623 for ENCRYPTION FOR MODULATED BACKSCATTER SYSTEMS, issued Oct. 10, 2000 to John Austin MacLellan, et al.; and U.S. Pat. No. 6,842,106 for CHALLENGED-BASED TAG AUTHENTICATION MODEL, issued Jan. 11, 2005 to Michael A. Hughes, et al.

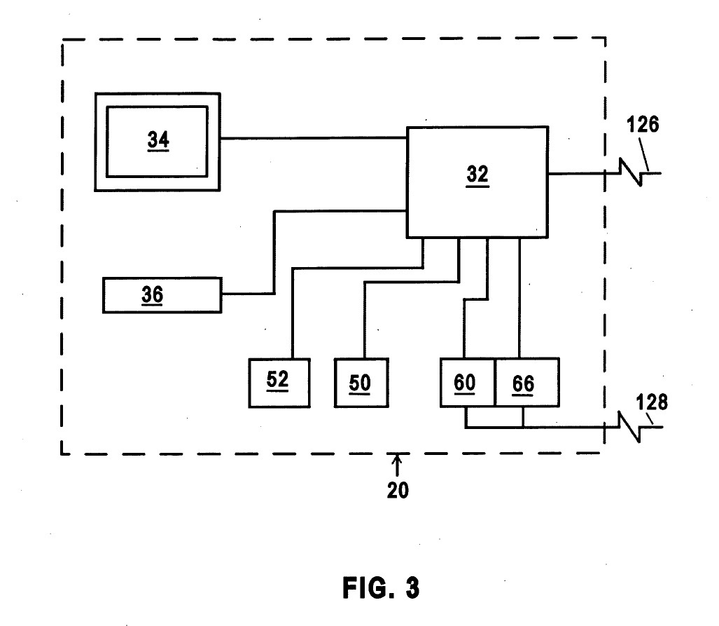

FIG. 3 schematically depicts the primary electronic components, communication and control within the VT kiosk 20. The VT kiosk 20 includes a kiosk controller/processor 32 which acts as the primary electronic control unit for the VT kiosk 20, and includes a processor and defined protocol program to control operation of the VT kiosk 20. The kiosk controller/processor 32 is electronically connected to control the video screen 34, card reader 36, ticket printer 50, ticket acceptor 52, bill validator 60 and intelligent cash box (ICB) 66. The kiosk controller/processor 32 is also communicatively coupled to an external computer system as depicted by line 126, although the communication may be via a wireless network. The bill validator 60 and the intelligent cash box (ICB) 66 are independently or redundantly communicatively coupled to either the same external computer system or another monitoring system or operating backend retail system as depicted by line 128, although again the communication may be via the same or totally different wired or wireless network.

The VT kiosks 20 are intended to be dispersed at retail outlets throughout a given state. In order to provide centralized control of the lottery system, however, all of the kiosks are electronically connected, for example by a telephone line, Ti line, fiber optic communication line or cell based communication technologies, to a monitoring hub and a state-monitored centralized computer system. The bill validator 60 of the present invention is configured so as to be both communicatively coupled to the VT kiosk 20 and there-through, independently by means of its own cell based or other type of wireless communication technology device, to the state-monitored computer system. Bill validator 60 is also configured so as to allow communication from the intelligent cash box (ICB) 66 whenever it is within the bill validator 60 and the VT kiosk 20 as well as to the centralized monitoring computer system.

The ticket acceptor 52 may be configured to read a play slip as well as a game or lottery ticket. A play slip is a form on which a participant's selected set of numbers for a particular lottery game can be identified. Preferably, the play slip is configured such that the selected numbers are machine readable. When a play slip is read by the ticket acceptor 52, the ticket stacker will cause a prompt on the video screen 34 to confirm the selections. If a selection has an error, for example, five or seven numbers on a pick six game are identified, the defect can be displayed on the video screen 34 so that it may be addressed either on the video screen 34 or by canceling the play slip scan, fixing the play slip and reinserting the play slip. Once a game selection has been properly entered, the video screen 34 prompts the participant to insert currency into the bill validator or swipe a transaction card in order to pay for and receive a game ticket. Play slips will not be stacked or retained by the ticket acceptor 52 as often a play slip is used more than once. Alternately, the bill validator 60 could have the ability as mentioned above to scan and validate play slips and/or tickets as well as being able to transfer said play slips or tickets to the ticket stacker. Further, the video screen 34 may be configured as an interactive touch screen controlled by the kiosk controller/processor 32, to allow users to selected numbers for a lottery ticket directly on the touch screen, as opposed to via a play slip.

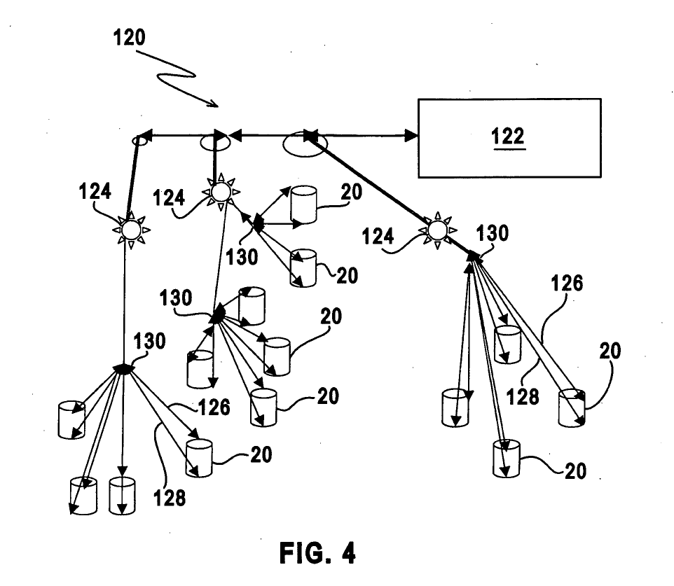

The ticket acceptor 52 is also configured to receive and read game or lottery tickets and determine if a payout on the ticket is appropriate. To do so, the ticket acceptor 52 reads the bar code or encoded information on the game or lottery ticket and verifies whether the ticket is a winning ticket via the network connection to the centralized computer system 122 (FIG. 4). If the game ticket is a winning ticket, the centralized computer system 122 will instruct the VT kiosk 20 the amount that has been won. For amounts over a selected threshold, for example $100, the participant will be advised of who to contact either via the video screen 34 or on the printed slip and the winning game ticket is returned.

For a winning game ticket having a value below the threshold, the kiosk controller/processor 32 will determine if the bill validator 60 includes sufficient cash to pay out the winnings. The video screen 34 will prompt the participant to select a cash payout or credit toward the purchase of additional game tickets and provide the response to the kiosk controller/processor 32. The kiosk controller/processor 32 will instruct the bill validator 60 to dispense currency or ticket printer 50 to print a new ticket depending on the selection of the player.

FIG. 4 schematically depicts a dispersed lottery system 120 utilizing the present invention. The lottery system 120 includes a number of kiosks 20, each represented as having two lines of communication to a state-monitored centralized computer system 122 via hubs 124. The two communication lines 126 and 128 for each VT kiosk 20 are representative of the communication to both the VT kiosk 20 and independently to the intelligent cash box (ICB) 66 contained within the bill validator 60 by way of either the RFID technology communication between the RFID tag device and RFID interface device or by other wireless means such as IrDA communication between the bill validator 60 and the cash box (ICB) 66. As illustrated, a number of VT kiosks 20 can be communicatively interconnected to a terminal 130 which itself is communicatively interconnected to a monitoring system hub 124, and each of the monitoring system hubs 124 is connected to the state-monitored centralized computer system 122 as well as potentially to back end retail systems. It should be understood that through the use of other known forms of wireless communications, such as cell based technology for example, the communication lines 126 and 128 could alternatively make direct contact to the monitoring system 122 or other authorized auditing system.

For a retail organization that has multiple kiosk locations, the organization could receive the kiosk information on an internal terminal 130 and therefrom report to the central computer system 122. By the system of the present invention, information concerning all of the cash receipts in each kiosk, and specifically within each cash box of each bill validator in each kiosk, can be reported both to the state and to operators on a real time basis.

The lottery system 120 as discussed above provides the ability to independently monitor and watch the daily revenue from each individual VT kiosk 20 throughout the system. The VT kiosks 20 can be integrated into the current distribution system without substantial changes other than additional communication lines and respective software. The VT kiosks 20 store all the monies received in a cash box and the human operator aspect of the lottery is removed.

The use of the lottery system 120 as described above, a state will know instantly the amount of the money that it has received from the lottery and can run reports on a daily, weekly, monthly, or other periodic real time basis so as to maintain accurate reporting and distribution according to the guidelines which establish the state-run lottery. Indeed, the lottery system 120 discussed above allows the state to monitor networks of VT kiosks 20 or single machines in the network, with direct monitoring of the cash in each VT kiosk 20.

The lottery system 120 also has advantages for the retailer or the retail headquarters within the state that operates the respective kiosks. The retailer can receive reports similar to the reports received by the state of all the revenues generated by the kiosks in several different locations. Since retailers are guaranteed a percentage of the receipts for each of the machines, the retailer will need a report in order to identify the amount of money that should be paid from the state to the retailer.

With this system, the retail outlets will have supervisory personnel who are responsible for collecting money from the kiosks and generating a report of the activity of the kiosk to submit to the state. Alternatively, the state can appoint representatives who will be responsible for collecting revenues received at the kiosks. The monitoring system can provide a report for each of the cash boxes which have reached capacity and thus need to be serviced because the intelligent cash box (ICB) will know exactly the number of bills which it has received and stored. For terminals that have the capacity to pay out at least selected denominations of winning tickets, the terminals will themselves reduce the money in circulation and the necessity for frequent servicing, as a kiosk which pays out a $100 ticket inherently reduces it own inventory of currency. All such transactions are similarly monitored though the state and the paid out tickets are escrowed within the ticket acceptor 52 of the kiosk 20.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thereof.

What is claimed is:

1. A video ticket kiosk comprising:
a housing and a face plate mounted to the housing;
a kiosk controller for controlling the operation of the video ticket kiosk based on a control program;
a video screen mounted in said face plate and connected to and controlled by said kiosk controller;
a bill validator mounted within said housing for receiving and validating currency and for reporting to said kiosk controller;
a printer mounted within said housing and controlled by said kiosk controller to print and dispense coded game tickets; and
a ticket acceptor mounted within said housing having a scanner to read said coded game tickets and play slips and a communication device to provide information from said scanner to said kiosk controller.

2. The video ticket kiosk of claim 1, wherein said bill validator further comprises:
a validation assembly for sensing data relating to the currency inserted into said bill validator and for generating and sending signals corresponding to the sensed data to said kiosk controller;
a transportation assembly for transporting currency within said bill acceptor; and
a cash box for receiving and storing currency validated by said validation assembly, said cash box being removable from said bill validator.

3. The video ticket kiosk of claim 2, wherein said cash box further comprises:
an electronics assembly including a cash box memory and a cash box communications link to allow communication between said cash box memory and said validation assembly.

4. The video ticket kiosk of claim 2, wherein said validation assembly includes an external communication link for communicatively coupling said cash box memory to an external monitoring system.

5. The video ticket kiosk of claim 3 wherein said cash box memory and said cash box communications link are contained in a radio frequency identification device.

6. The video ticket kiosk of claim 1 wherein said radio frequency identification device limits access to at least some of the information stored thereon by encryption.

7. The video ticket kiosk of claim 2 wherein said cash box further includes a global positioning system device.

8. The video ticket kiosk of claim 2 wherein said cash box further includes a global system for mobile communications device.

9. The video ticket kiosk of claim 3 wherein said cash box further includes a global positioning system device.

10. The video ticket kiosk of claim 3 wherein said cash box further includes a global system for mobile communications device.

11. The video ticket kiosk of claim 1 wherein said ticket acceptor further comprises a transportation assembly to transport game slips from said scanner to a stacker upon receipt of an instruction from said kiosk controller.

12. The video ticket kiosk of claim 1 wherein said video screen connected to said kiosk controller displays information and accepts the input of information on a touch screen, said video touch screen being coupled to and controlled by said kiosk controller.

13. The video ticket kiosk of claim 1 further comprising:
a kiosk control program in said kiosk controller to control the operation of the kiosk, including acceptance of currency by said bill validator and the printing and dispensing of game tickets by said printer based upon the value of the currency accepted.

14. The video ticket kiosk of claim 1 further comprising:
a communication device to allow said kiosk controller to communicate with a remote centralized computer system that controls the operation of the lottery.

15. The video ticket kiosk of claim 4, wherein currency validation and acceptance transactions carried out by said kiosk are reported to said external monitoring system.

16. The video ticket kiosk of claim 1 further comprising:
a magnetic card reader operatively coupled to said kiosk controller.

17. The video ticket kiosk of claim 1 wherein said bill validator further comprises a dispenser and dispenser controller to allow dispensing of currency from said bill validator.

18. The video ticket kiosk of claim 17 wherein said kiosk controller further comprises a control program to control the dispensing of currency by said dispenser as change and as a payout of a coded game ticket received by said ticket acceptor.

19. A ticket kiosk comprising:
a housing having a face plate;
a video touch screen mounted on said face plate;
a ticket printer mounted within said housing;
a bill validator mounted within said housing;
a ticket acceptor mounted within said housing; and
a kiosk controller operatively coupled to said video touch screen, said ticket printer, said bill validator and said ticket acceptor, said kiosk controller including means for communicating information concerning all transactions carried out by the video ticket kiosk to a remote computer operating system.

20. The ticket kiosk of claim 19 wherein said kiosk controller enables acceptance of currency by said bill validator, printing and dispensing of coded game tickets by said ticket printer based on the receipt of sufficient currency, and input and reading of a play slip inserted into said ticket acceptor.

21. The ticket kiosk of claim 19 wherein said kiosk controller receives information on number selections from said ticket acceptor and displays said information on said video touch screen and receives confirmation of the information from said video touch screen prior to causing the printing of a coded game ticket.

22. The ticket kiosk of claim 19, wherein said bill validator further comprises:
a removable cash box for receiving and storing currency validated by said bill validator, said cash box including a memory device and a communication link to said kiosk controller to allow data exchange between said memory and said kiosk controller.

23. A cash box for a kiosk having a housing and a bill validator; said cash box comprising:
a box for receiving and storing currency validated by said bill validator;
a memory device; and
a communication link.

24. The cash box for a kiosk of claim 23 wherein said cash box memory and said cash box communications link are contained in a radio frequency identification device.

25. The cash box for a kiosk of claim 24 wherein said radio frequency identification device limits access to at least some of the information stored thereon by encryption.

26. The cash box for a kiosk of claim 23 wherein said cash box further includes a global positioning system device.

27. The video ticket kiosk of claim 23 wherein said cash box further includes a global system for mobile communications device.

28. A method of dispensing and validating lottery tickets in a state run lottery game, comprising:
providing ticket kiosk having a housing with a video touch screen mounted on face plate, a ticket printer, a bill validator and a ticket acceptor all mounted within said housing; and a kiosk controller operatively coupled to said video touch screen, said ticket printer, said bill validator and said ticket acceptor, said kiosk controller including means for communicating information concerning all transactions carried out by the video ticket kiosk to a remote computer operating system which controls the lottery;
accepting currency input into said bill validator to accumulate credits for purchasing lottery tickets;
accepting play slips input into said ticket acceptor;
printing lottery tickets on said ticket printer based on the play slips accepted by said ticket acceptor;
dispensing said printed lottery tickets and reporting the issuance of the lottery tickets and acceptance of the currency to said remote computer operating system.

29. The method of claim 28, further comprising:
providing a cash box for said bill validator, said cash box including at least one of:
a memory device;
a communication link;
a global positioning system device; and
a global system for mobile communications device.
